(19) United States
(12) Patent Application Publication
(10) Pub. No.: US 2026/0311154 A1
(43) Pub. Date: Oct. 8, 2026

(54) Single-Tap Vending System with Integrated Payment and Dispensing Operations

(71) Applicant: Matthew Aaron Pfaltzgraf, Atlanta, GA (US)

(72) Inventor: Matthew Aaron Pfaltzgraf, Atlanta, GA (US)

(21) Appl. No.: 19/195,762

(22) Filed: May 1, 2025

Related U.S. Application Data
(60) Provisional application No. 63/784,183, filed on Apr. 6, 2025.

(51) Int. Cl. G06Q 20/18; G06K 7/10; G06Q 20/20; G06Q 20/40; G07F 11/58

(52) U.S. Cl. CPC G06Q 20/18; G06Q 20/204; G06Q 20/4014; G07F 11/58; G06K 7/10297

(57) ABSTRACT

A vending system is provided comprising a housing configured to store a plurality of products, a plurality of payment authentication modules positioned at respective product locations on the housing, each payment authentication module comprising a contactless payment reader configured to detect a payment device and process a payment transaction, and a plurality of product dispensing mechanisms each associated with one of the payment authentication modules. A controller is operably coupled to the payment authentication modules and the product dispensing mechanisms, the controller configured to detect a payment transaction initiated at one of the payment authentication modules, authenticate the payment transaction, and operate the product dispensing mechanism associated with the payment authentication module to release the corresponding product. The system enables product selection and payment authentication to occur through a single user interaction.

### CROSS-REFERENCE TO RELATED APPLICATIONS

This application claims the benefit of priority under 35 U.S.C. § 119(e) to U.S. Provisional Patent Application No. 63/784,183, filed on Apr. 6, 2025, the entire contents of which are incorporated herein by reference.

### FIELD OF INVENTION

The present invention relates generally to automated vending systems and, more particularly, to vending systems configured to integrate product selection and payment authentication into a single user interaction through contactless payment readers.

### BACKGROUND

Self-service vending machines have historically relied on a multi-stage user interaction model involving separate selection and payment processes. Users are typically required to enter a product code using mechanical buttons, touchscreens, or keypads, followed by a distinct and subsequent payment step involving cash insertion, card swiping, or, in more modern systems, tapping a contactless payment device. Although these designs have become commonplace, they introduce friction into the transaction process, particularly by requiring multiple user actions, sequential confirmations, and potential confusion regarding the order of operations.

As public expectations for transactional efficiency and hygiene have increased, attempts have been made to streamline vending machine interactions. Some systems have introduced contactless payment capabilities or mobile application interfaces that allow users to browse available products on their devices. However, these solutions often continue to require navigation of a separate selection interface, user familiarity with specific applications, or maintenance of continuous network connectivity. As a result, they can increase cognitive load, exclude certain user demographics, and introduce new potential points of failure in environments where rapid, intuitive transactions are preferred.

Another persistent drawback of conventional vending systems is the reliance on mechanical and digital input interfaces that are vulnerable to environmental wear, vandalism, or contamination. Buttons, touchscreens, and keypads are physical contact points that degrade over time and are perceived as unhygienic, particularly in high-traffic public areas. While some modern systems attempt to minimize touch interaction by offering mobile browsing and remote selection, these approaches inherently require users to possess compatible devices, install specific applications, and navigate non-standardized user experiences, thereby limiting inclusivity and slowing transaction throughput.

The closest prior art identified, including vending systems that offer contactless payment combined with product dispensing, still maintains a fundamental separation between selection and payment stages. Systems such as those disclosed in US20180358572A1 and JP2020034567A exemplify architectures where users must first select a product, often via touchscreen or mechanical input, and only thereafter complete a payment. These systems continue to suffer from drawbacks such as requiring multiple discrete user actions, imposing additional decision points that slow transaction speed, and creating potential for transactional errors or user hesitation. Furthermore, prior art configurations typically rely on centralized payment readers rather than embedding dedicated payment detection at the point of selection, thereby necessitating multiple physical or cognitive steps to complete a transaction.

There remains a need for an improved vending system that eliminates the separation between product selection and payment authentication, simplifying the user interaction into a single, intuitive action while maintaining security and transactional reliability. Such a system should reduce mechanical complexity, minimize the need for extraneous interfaces or mobile applications, and deliver a highly accessible experience that promotes faster transaction throughput across a wide range of deployment environments.

It is within this context that the present invention is provided.

### SUMMARY

The present invention relates to a vending system configured to enable product selection and payment authentication through a single user interaction. The system includes a housing configured to store a plurality of products, a plurality of payment authentication modules positioned at respective product locations, and a plurality of product dispensing mechanisms each associated with one of the payment authentication modules. Each payment authentication module comprises a contactless payment reader configured to detect a payment device and process a payment transaction. A controller is operably coupled to the plurality of payment authentication modules and the plurality of product dispensing mechanisms, and is configured to detect a payment transaction, authenticate the payment transaction, and operate the associated product dispensing mechanism to release the selected product.

By directly associating each payment authentication module with a product dispensing mechanism, the system enables product selection and payment to occur simultaneously through a single tap interaction. The system simplifies user experience, reduces mechanical complexity, and minimizes transaction time without requiring the use of touchscreens, keypads, or separate selection interfaces. In addition, the system architecture supports modular installation, enhanced hygiene, and improved system reliability in a wide range of vending applications.

In some embodiments, each contactless payment reader is configured to operate according to Near Field Communication (NFC) or Radio-Frequency Identification (RFID) protocols, ensuring compatibility with a wide variety of commercially available payment devices while maintaining secure, standardized communications.

In further embodiments, each contactless payment reader is configured to detect payment devices within a range of approximately 2 to 10 centimeters, enhancing user accuracy and preventing unintended activations of neighboring product locations.

In some embodiments, the plurality of payment authentication modules are integrated behind a translucent panel of the housing, providing a protected, visually appealing interface while preserving the functionality of the contactless payment readers.

In further embodiments, the controller is configured to authenticate the payment transaction locally at the payment authentication module prior to operating the associated dispensing mechanism, improving system response time and reducing dependence on external network communication.

In some embodiments, the controller monitors the plurality of payment authentication modules using a multiplexed communication protocol, optimizing system efficiency and reducing wiring complexity within the housing.

In further embodiments, the vending system includes a visual feedback system associated with each payment authentication module, providing real-time user guidance during payment and dispensing operations.

In some embodiments, the visual feedback system comprises light-emitting diodes configured to indicate states such as standby, payment processing, payment success, and payment error, thereby improving user clarity and operational reliability.

In further embodiments, each product dispensing mechanism comprises a solenoid actuator configured to selectively release the corresponding product, providing a compact and mechanically reliable dispensing solution.

In some embodiments, each product dispensing mechanism comprises a motorized conveyor or tilting platform configured to deliver the corresponding product to a collection area, allowing flexible handling of a range of product types and sizes.

In further embodiments, the controller is configured to log transaction data associated with each payment transaction, supporting transaction auditing, system monitoring, and inventory management.

In some embodiments, the controller is operably coupled to a wireless communication module configured to transmit transaction data to a remote system, enabling remote system management and diagnostic reporting.

In further embodiments, the wireless communication module is configured for communication over Wi-Fi networks, cellular networks, or Bluetooth networks, enhancing deployment flexibility across diverse environments.

In some embodiments, the housing is configured to display the plurality of products behind transparent or translucent panels, improving product visibility while protecting the internal components.

In further embodiments, the controller comprises a microcontroller selected from a 32-bit ARM Cortex series processor, providing sufficient real-time processing capabilities for managing payment, dispensing, and feedback operations.

In some embodiments, the payment authentication modules are configured to operate in an offline mode by storing pre-authorized transaction data for later reconciliation, enabling operation in environments with limited network connectivity.

In further embodiments, the housing is configured to be wall-mounted, pedestal-mounted, or freestanding, supporting installation flexibility for a variety of deployment scenarios.

In some embodiments, the payment authentication modules and product dispensing mechanisms are arranged in a grid layout on the housing, providing an organized, intuitive arrangement for users.

In further embodiments, the controller is configured to control the timing of activation of each product dispensing mechanism based on successful payment authentication signals, ensuring accurate and reliable dispensing operations.

In some embodiments, the housing comprises a collection area positioned below the plurality of products for receiving released products, facilitating easy user access to dispensed items.

### BRIEF DESCRIPTION OF THE DRAWINGS

Various embodiments of the invention are disclosed in the following detailed description and accompanying drawings.

FIG. 1 illustrates an example block diagram of a single-tap vending system showing the major system components and their interconnections.

FIG. 2 illustrates an example operational flow diagram of the single-tap vending system depicting the sequence from detecting a payment device to product dispensing.

FIG. 3 illustrates an example front panel layout of the single-tap vending system showing the arrangement of product displays, tap-to-pay zones, feedback indicators, and the collection area.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

### Definitions

The terminology used herein is for the purpose of describing particular embodiments only and is not intended to be limiting of the invention.

As used herein, the term “and/or” includes any combinations of one or more of the associated listed items.

As used herein, the singular forms “a,” “an,” and “the” are intended to include the plural forms as well as the singular forms, unless the context clearly indicates otherwise.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

When a feature or element is described as being “on” or “directly on” another feature or element, there may or may not be intervening features or elements present. Similarly, when a feature or element is described as being “connected,” “attached,” or “coupled” to another feature or element, there may or may not be intervening features or elements present. The features and elements described with respect to one embodiment can be applied to other embodiments.

The use of spatial terms, such as “under,” “below,” “lower,” “over,” “upper,” etc., is used for ease of explanation to describe the relationship between elements when the apparatus is in its proper orientation.

The term “payment authentication module” refers to any hardware or combination of hardware and software configured to securely detect and process payment information from a payment device. This includes, but is not limited to, Near Field Communication (NFC) readers, Radio-Frequency Identification (RFID) readers, and associated secure payment processing circuits positioned at individual product locations. In one example implementation, the payment authentication module may comprise an NFC antenna tuned to a frequency of approximately 13.56 MHz, integrated with a secure transaction processor configured to execute encrypted protocols compliant with EMV standards.

The term “controller” refers to any processing unit, microcontroller, microprocessor, application-specific integrated circuit (ASIC), field-programmable gate array (FPGA), or system-on-chip (SoC) configured to manage operation of the vending system components. This includes executing logic for monitoring payment authentication modules, validating transactions, initiating operation of product dispensing mechanisms, controlling feedback systems, and managing communication with external networks. In one example implementation, the controller may be a 32-bit ARM Cortex-M4 processor operating at a clock speed of approximately 120 MHz, coupled to non-volatile memory for firmware storage and volatile memory for transaction and operational data processing.

The term “feedback system” refers to any hardware components configured to provide sensory output to a user, including but not limited to visual, audible, or haptic signals. In one example implementation, the feedback system may comprise addressable RGB light-emitting diodes (LEDs) positioned adjacent to each payment authentication module, programmed to emit different colors or flashing patterns corresponding to transaction states such as idle, payment in progress, successful authentication, or error. In another example implementation, the feedback system may include a miniature speaker configured to produce confirmation tones or error alerts.

The term “product dispensing mechanism” refers to any mechanical, electromechanical, or fluidic assembly configured to selectively release a product from a storage position into a user-accessible area upon receiving a control signal. This includes, but is not limited to, solenoid-actuated release mechanisms, motor-driven conveyor belts, rotating carousels, gravity-fed chutes, and pneumatic or spring-loaded ejection systems. In one example implementation, the product dispensing mechanism may include a solenoid actuator retracting a retention pin, allowing the product to fall under gravity into a designated collection area.

The term “housing” refers to any structural enclosure configured to physically support, organize, and protect the internal components of the vending system, including the payment authentication modules, product storage areas, dispensing mechanisms, controller, and power supply components. In one example implementation, the housing may be constructed from powder-coated sheet metal for structural rigidity and corrosion resistance, with front panels formed from durable materials such as polycarbonate or acrylic to allow visibility of the products while protecting the contactless payment interfaces.

The term “payment device” refers to any device capable of transmitting payment information to a payment authentication module without requiring direct physical contact. This includes, but is not limited to, contactless credit cards, debit cards, smartphones with NFC capability, smartwatches, wristbands, and other wearable devices configured to store and transmit secure payment credentials. In one example implementation, the payment device may be a mobile phone equipped with a secure element that enables encrypted communication with a payment reader over a short-range NFC channel.

The term “wireless communication module” refers to any integrated transceiver or communication system configured to transmit and/or receive data wirelessly between the vending system and external platforms. This includes, but is not limited to, modules operating in accordance with IEEE 802.11 Wi-Fi standards, cellular communication modules compatible with LTE or 5G networks, and Bluetooth or Bluetooth Low Energy (BLE) modules. In one example implementation, the wireless communication module may include an LTE modem configured to transmit inventory status, transaction logs, and system diagnostics to a remote management server via a secure virtual private network (VPN) connection.

The term “collection area” refers to any defined region of the housing accessible to a user for retrieving a dispensed product after a successful transaction. In one example implementation, the collection area may comprise a recessed cavity at the lower portion of the vending unit, optionally lined with an energy-absorbing material such as thermoplastic elastomer (TPE) to protect dispensed products from impact damage.

### DESCRIPTION OF DRAWINGS

The present invention provides a vending system configured to streamline and simplify the product selection and payment process by integrating both actions into a single user interaction. In contrast to traditional vending systems, which typically require users to separately select a product and subsequently initiate a payment process, the vending system disclosed herein merges selection and payment into a single tap action at the point of sale. This configuration eliminates the need for intermediate interfaces such as keypads, touchscreens, or mobile applications, thereby minimizing transaction time, reducing cognitive load on users, and improving system durability by eliminating common mechanical points of failure.

Prior vending systems that introduced contactless payment still relied on conventional two-stage interaction models, maintaining a logical separation between selection and payment that introduced unnecessary complexity and potential for user error. These systems often presented barriers to accessibility, introduced additional maintenance burdens, and slowed transaction throughput, particularly in high-traffic environments. Furthermore, systems that employed centralized payment readers required users to navigate product menus or input codes, creating confusion and opportunities for transactional mismatch between selected and dispensed products.

The vending system described herein addresses these drawbacks by positioning a dedicated payment authentication module at each product location. Each module is configured to detect and authenticate a payment transaction locally, allowing immediate triggering of the corresponding product dispensing mechanism. By mapping each payment reader directly to an individual product, the system ensures unambiguous transaction flow, providing a fast, intuitive, and hygienic interaction that supports a wide variety of payment devices compliant with contactless standards. The system architecture also supports modular scaling, enabling flexible deployment across different physical layouts and product assortments.

The vending system further incorporates visual feedback elements, such as LEDs positioned near each payment interaction point, to provide users with real-time confirmation of transaction states including standby, payment processing, success, or error. The dispensing mechanisms may be implemented using solenoid actuators, motorized conveyors, or other suitable systems depending on the nature of the products offered. The central controller coordinates the operation of the payment authentication modules, feedback systems, and dispensing mechanisms, and may optionally interface with wireless communication modules to facilitate remote inventory management, transaction logging, and system diagnostics.

Throughout the following detailed description, references to specific configurations and implementations are intended to illustrate, but not to limit, the scope of the invention as defined by the appended claims. Variations in component selection, system layout, communication protocols, and dispensing strategies are contemplated within the scope of the invention, provided that the core functionality of single-tap product selection and payment authentication is preserved.

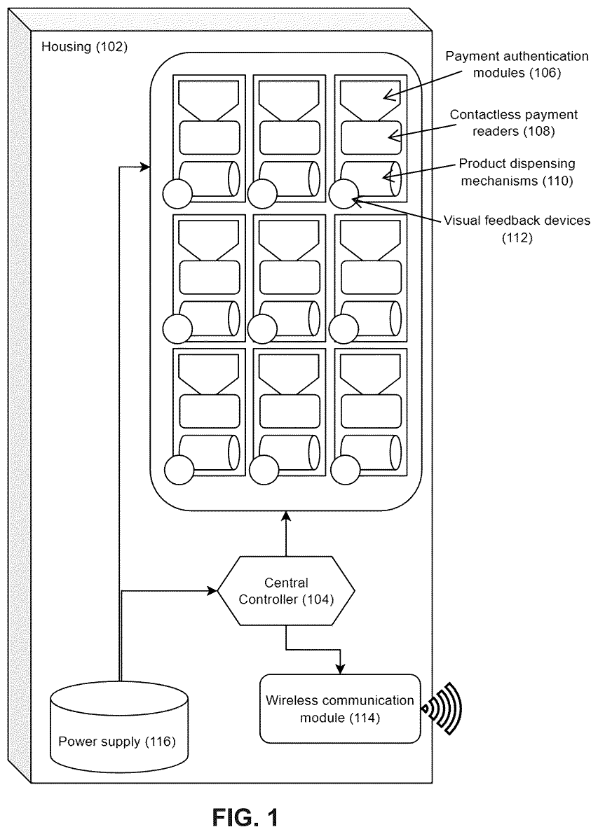

Referring now to the drawings, FIG. 1 illustrates a block diagram of an example single-tap vending system 100. A housing 102 is shown enclosing the system components. The housing 102 may be wall-mounted, kiosk-integrated, or freestanding, and may be formed from materials such as powder-coated sheet metal, stainless steel, or polymer composites to provide durability and environmental resistance. In some embodiments, the front face of the housing 102 may include transparent or translucent panels formed from polycarbonate or acrylic materials to protect internal components while allowing visibility of the products stored therein. Positioned within the housing 102 is a central controller 104 configured to manage system operations. The controller 104 may be implemented using a 32-bit ARM Cortex-M series microcontroller or other real-time capable embedded processors, and may be coupled to non-volatile memory for firmware storage and volatile memory for real-time transaction processing. A plurality of payment authentication modules 106 are operably coupled to the controller 104. Each payment authentication module 106 is dedicated to a respective product location and includes a contactless payment reader 108 configured to detect a payment device and process a transaction. The payment readers 108 may conform to standards such as ISO/IEC 14443 Type A and B, and may be certified under EMVCo standards. In preferred embodiments, the payment readers 108 are tuned to detect devices within approximately 2 to 10 centimeters to ensure precise user interactions. Each payment authentication module 106 is directly associated with a corresponding product dispensing mechanism 110. The product dispensing mechanisms 110 may include solenoid-actuated release pins, motorized conveyors, belt systems, or gravity-fed chutes, depending on the product type. In one example, a solenoid actuator may retract a spring-loaded pin upon successful payment authentication to release the selected product into a collection area. The vending system 100 further includes visual feedback devices 112, such as multicolor addressable LEDs, positioned adjacent each payment authentication module 106 to provide real-time status feedback to users. The visual feedback devices 112 may indicate standby, payment processing, transaction approval, or error states through varying colors or flashing patterns. A wireless communication module 114 may be operably connected to the controller 104 to enable remote inventory management, transaction logging, firmware updates, and system diagnostics. The wireless communication module 114 may support Wi-Fi, LTE, or Bluetooth Low Energy (BLE) protocols, and may utilize encrypted channels such as HTTPS or MQTT. A power supply 116 is provided to supply regulated voltage to all system components. The power supply 116 may derive from standard AC mains input or, in alternative embodiments, from rechargeable lithium-ion battery packs configured with integrated battery management systems.

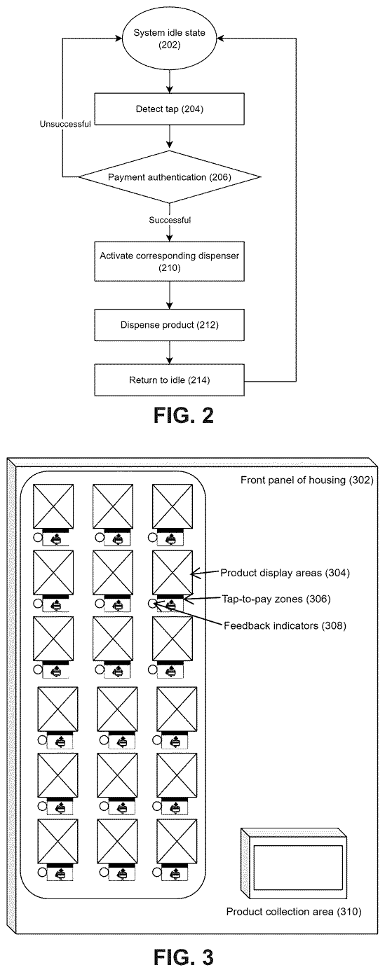

FIG. 2 illustrates an example operational flow diagram of the vending system 200. The system initially resides in an idle state 202, where the controller maintains the payment authentication modules 106 in readiness to detect user interaction while minimizing power consumption. Visual feedback devices 112 may display a soft pulsing light during the idle state to attract attention without excessive energy use. When a user presents a payment device near a payment authentication module 106, the system detects the tap at a specific product location at step 204. The controller 104 then initiates payment authentication at step 206. If the payment is successfully authenticated, as determined at decision point 208, the controller 104 sends a signal to operate the corresponding product dispensing mechanism 110 at step 210. Upon receiving the control signal, the selected product dispensing mechanism 110 actuates to release the associated product. The dispensed product is delivered to a collection area, and the system logs the transaction and resets to the idle state 214. If payment authentication fails, the system transitions directly back to idle without initiating a dispense action, and an error indicator may be briefly displayed on the associated visual feedback device 112. In some embodiments, the transaction timeout period may be configured to reset the system automatically if no action is completed within a predetermined time window, thereby conserving system resources.

FIG. 3 illustrates an example front panel layout 300 of the single-tap vending system. A front panel 302 is shown, which may be formed from durable materials such as polycarbonate or acrylic and configured to support product display and user interaction zones. A plurality of product display areas 304 are arranged on the front panel 302. Each product display area 304 may present a visual representation of the associated product, such as a transparent window showing the product, a printed image, or a digital screen. Adjacent to each product display area 304 is a tap-to-pay zone 306. Each tap-to-pay zone 306 is associated with an underlying contactless payment reader 108 and is configured to enable a user to complete both selection and payment by tapping a compatible payment device over the zone. In exemplary embodiments, a flexible NFC antenna may be laminated behind the tap-to-pay zone 306 to provide seamless user interaction without protruding hardware. Positioned near each tap-to-pay zone 306 is a feedback indicator 308, which may comprise an addressable multicolor LED. The feedback indicators 308 provide visual confirmation of transaction states, such as idle, payment detected, payment approved, or error, according to color or flashing patterns controlled by the controller 104. A collection area 310 is located at the lower portion of the front panel 302 to allow users to retrieve dispensed products. In some examples, the collection area 310 may be recessed and lined with an energy-absorbing material such as thermoplastic elastomer to minimize product impact during dispensing. The arrangement of the product display areas 304, tap-to-pay zones 306, and feedback indicators 308 may be configured in a grid, column, or staggered layout depending on the form factor of the housing 102 and the nature of the products being offered. Alternative embodiments may include customization of the front panel 302 to incorporate branding elements, additional accessibility features such as tactile indicators, or integration with environmental lighting controls to improve system visibility in low-light conditions.

### Controller/Processor Components

A controller as described herein may include any suitable type of computing device configured to manage operation of the single-tap vending system, such as a microcontroller, central processing unit (CPU), system on a chip (SoC), field-programmable gate array (FPGA), or application-specific integrated circuit (ASIC). The controller may operate with one or more cores and may be configured to execute the functions associated with monitoring payment authentication modules, authenticating payment transactions, operating product dispensing mechanisms, managing feedback systems, and facilitating optional wireless communication.

The controller may be operably connected to one or more memory devices, such as random access memory (RAM), read-only memory (ROM), flash storage, or equivalent non-volatile memory components. These memory devices store computer-readable instructions that, when executed by the controller, perform the transaction processing, dispensing control, and communication management methods described herein. Communication between the controller and the memory devices may occur via data buses or other suitable communication pathways, such as SPI, I²C, or UART connections.

The controller may further interface with various input/output (I/O) devices associated with the vending system, including but not limited to the contactless payment readers, visual feedback indicators, dispensing actuators, and wireless communication modules. In some embodiments, the controller may include network interfaces configured for wireless connectivity to external systems via Wi-Fi, LTE, or Bluetooth Low Energy (BLE) protocols.

Control logic or executable software instructions may be stored within the memory devices and executed by the controller to implement the operational sequences of the vending system. This logic may be modular in structure, comprising distinct software components, firmware routines, or processing tasks that interact to perform the operations associated with payment detection, authentication, dispensing control, and system state management.

The described computing operations involve the manipulation of data represented as electrical, optical, or magnetic signals stored within memory or transferred between system components. These operations are machine-executed and do not require manual intervention, although human operators may indirectly interact with the system through the designated tap-to-pay zones and feedback indicators provided at each product location.

The systems and methods disclosed are not limited to any particular hardware configuration, memory architecture, or programming language and may be implemented on general-purpose embedded controllers, specialized vending control systems, or future equivalents offering suitable real-time processing, secure storage, and peripheral interface capabilities.

### Conclusion

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the touchless vending system of the invention have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A vending system comprising:
a housing configured to store a plurality of products;
a plurality of payment authentication modules positioned at respective product locations on the housing, each payment authentication module comprising a contactless payment reader configured to detect a payment device and process a payment transaction;
a plurality of product dispensing mechanisms, each product dispensing mechanism associated with one of the plurality of payment authentication modules and configured to release a corresponding product;
a controller operably coupled to the plurality of payment authentication modules and the plurality of product dispensing mechanisms, the controller configured to:
detect a payment transaction initiated at one of the payment authentication modules;
authenticate the payment transaction at the one payment authentication module; and
operate the product dispensing mechanism associated with the one payment authentication module to release the corresponding product.

2. The vending system of claim 1, wherein each contactless payment reader is configured to operate according to a communication protocol selected from the group consisting of Near Field Communication (NFC) and Radio-Frequency Identification (RFID).

3. The vending system of claim 1, wherein each contactless payment reader is configured to detect a payment device within a range of approximately 2 to 10 centimeters.

4. The vending system of claim 1, wherein the plurality of payment authentication modules are integrated behind a translucent panel of the housing.

5. The vending system of claim 1, wherein the controller is configured to authenticate the payment transaction locally at the one payment authentication module prior to operation of the associated product dispensing mechanism.

6. The vending system of claim 1, wherein the controller is further configured to monitor the plurality of payment authentication modules using a multiplexed communication protocol.

7. The vending system of claim 1, further comprising a visual feedback system associated with each of the plurality of payment authentication modules.

8. The vending system of claim 7, wherein the visual feedback system comprises a light-emitting diode configured to indicate at least one of a standby state, a payment processing state, a payment success state, or a payment error state.

9. The vending system of claim 1, wherein each product dispensing mechanism comprises a solenoid actuator configured to selectively release the corresponding product.

10. The vending system of claim 1, wherein each product dispensing mechanism comprises a motorized conveyor or tilting platform configured to deliver the corresponding product to a collection area.

11. The vending system of claim 1, wherein the controller is further configured to log transaction data associated with the payment transaction.

12. The vending system of claim 11, wherein the controller is operably coupled to a wireless communication module configured to transmit the transaction data to a remote system.

13. The vending system of claim 12, wherein the wireless communication module is configured for communication over at least one of a Wi-Fi network, a cellular network, or a Bluetooth network.

14. The vending system of claim 1, wherein the housing is configured to display the plurality of products behind transparent or translucent panels.

15. The vending system of claim 1, wherein the controller comprises a microcontroller selected from a 32-bit ARM Cortex series processor.

16. The vending system of claim 1, wherein the payment authentication modules are configured to operate in an offline mode by storing pre-authorized transaction data for later reconciliation.

17. The vending system of claim 1, wherein the housing is configured to be wall-mounted, pedestal-mounted, or freestanding.

18. The vending system of claim 1, wherein the payment authentication modules and product dispensing mechanisms are arranged in a grid layout on the housing.

19. The vending system of claim 1, wherein the controller is configured to control the timing of activation of each product dispensing mechanism based on successful payment authentication signals.

20. The vending system of claim 1, wherein the housing comprises a collection area positioned below the plurality of products for receiving the released products.
